(19) United States
(12) Patent Application Publication
(10) Pub. No.: US 2002/0092429 A1
(43) Pub. Date: Jul. 18, 2002

(54) Hypodermic needle and syringe sterilizing and destroying apparatus

(76) Inventor: David A. Sowers, Coral Springs, FL (US)

Correspondence Address: FRANK L. KUBLER, 13261 S.W. 54th Court, Miramar, FL, 33027, US

(21) Appl. No.: 09/764,570

(22) Filed: Jan. 18, 2001

(51) Int. Cl. B30B 15/34

(52) U.S. Cl. 100/45; 100/48; 100/316; 100/319; 100/102; 100/245; 100/246

(57) ABSTRACT

An apparatus for sterilizing and destroying hypodermic syringes and needles includes a waste compression cylinder having a cylinder side wall and a closed cylinder abutment end wall, and having a cylinder waste receiving port in the cylinder side wall and a waste releasing port in the cylinder side wall; a waste compression piston slidably retained within the waste compression cylinder; a piston drive mechanism drivably connected to the waste compression piston for driving the piston away from the abutment end wall to open space for receiving waste within the compression cylinder and for driving the piston toward and into close proximity with the cylinder abutment end wall to crush needles; a sterilizing air blowing mechanism oriented to blow sterilizing air into the compression cylinder; and an air heating mechanism for heating the sterilizing air to a sterilizing temperature.

### BACKGROUND OF THE INVENTION

1. Field of the Invention

The present invention relates generally to the field of hazardous waste disposal. More specifically the present invention relates to an apparatus which disposes of infectious and sharps waste by sterilizing, melting and compressing hypodermic syringes and sterilizing, crushing and encasing needles in melted syringe material. The apparatus includes a waste compression cylinder having a cylinder side wall and a closed cylinder abutment end wall and containing a waste compression piston and drivably connected to piston drive means, a cylinder waste receiving port in the side wall and a corresponding cylinder waste receiving door and having a waste releasing port in its side wall and waste receiving door displacement means which automatically opens and closes the waste receiving door to pass waste into the cylinder. The piston drive means slides the piston away from abutment end wall to open space for receiving waste and slides the piston toward and into close proximity with the cylinder abutment end wall to crush needles. A sterilizing air blowing means is provided and oriented to blow sterilizing air into the cylinder through entry and exit air ports and air heating means for heating the sterilizing air to a sterilizing temperature.

2. Description of the Prior Art

There have long been hypodermic syringes and needles requiring safe disposal after use. Various devices have been developed for destroying and sterilizing such medical waste. One example is an apparatus known as the STERITECH™ Medical Waste Treatment System for management of infectious and sharps waste. This system employs permeable heavy-duty bags known as red bags for receiving containers of infectious waste, and the waste is treated by exposure to steam to decontaminate the waste. After steam exposure, the waste is subjected to sufficient heat to melt the plastic syringes. A problem with the STERITECH™ apparatus is that it is a large, bulky free standing machine which is very costly to manufacture and to purchase.

It is thus an object of the present invention to provide an apparatus which sterilizes and destroys plastic hypodermic syringes and needles by heating the syringes and needles until they are sterilized and further heating them until the syringes begin to melt, and by subsequently crushing the syringes and needles so that the needles bend and the melted syringe material encases the bent needles.

It is another object of the present invention to provide such an apparatus which is highly compact and light weight, such that the apparatus can be carried by hand easily by a single person and kept on top of an ordinary table.

It is still another object of the present invention to provide such an apparatus which is safe and easy to operate.

It is finally an object of the present invention to provide such an apparatus which is relatively inexpensive to manufacture and is highly reliable.

### SUMMARY OF THE INVENTION

The present invention accomplishes the above-stated objectives, as well as others, as may be determined by a fair reading and interpretation of the entire specification.

An apparatus is provided for sterilizing and destroying hypodermic syringes and needles, including a waste compression cylinder having a cylinder side wall and a closed cylinder abutment end wall, and having a cylinder waste receiving port in the cylinder side wall and a waste releasing port in the cylinder side wall; a waste compression piston slidably retained within the waste compression cylinder; a piston drive mechanism drivably connected to the waste compression piston for driving the piston away from the abutment end wall to open space for receiving waste within the compression cylinder and for driving the piston toward and into close proximity with the cylinder abutment end wall to crush needles; a sterilizing air blowing mechanism oriented to blow sterilizing air into the compression cylinder; and an air heating mechanism for heating the sterilizing air to a sterilizing temperature.

The apparatus preferably additionally includes a waste receiving door movably covering the waste receiving port. The apparatus preferably still additionally includes a waste receiving door displacement mechanism for automatically opening and closing the waste receiving door to pass waste into the cylinder. The apparatus preferably further includes a timer for setting a duration for operation of the air blowing mechanism sufficient to cause sterilization of needles and syringes contained within the compression cylinder. The apparatus preferably still further includes a waste collection vessel positioned below the cylinder waste releasing port.

The apparatus preferably includes an apparatus housing having a housing wall and containing the compression cylinder and including compression cylinder mounting structures holding the compression cylinder in a substantially horizontal position. The apparatus further preferably includes a housing waste receiving opening in the housing wall located above and registering with the cylinder waste receiving port. The housing preferably includes a housing waste receiving door and a housing waste receiving door displacement mechanism. The housing preferably contains a waste collection vessel removably retained within the housing below the cylinder waste releasing port. The apparatus preferably additionally includes a vessel removal port and vessel removal door removably covering the vessel removal port for providing access to the collection vessel for periodic removal and emptying of the collection vessel.

The apparatus preferably further includes an apparatus circuit having operation duration and sequencing elements controlling operation of the cylinder waste receiving door and the piston drive mechanism. The preferably still further includes an apparatus circuit board electrically connected to the apparatus circuit and having apparatus controls.

### BRIEF DESCRIPTION OF THE DRAWINGS

Various other objects, advantages, and features of the invention will become apparent to those skilled in the art from the following discussion taken in conjunction with the following drawings, in which:

FIG. 1 is a perspective view of the preferred embodiment of the apparatus.

FIG. 2 is a cross-sectional top view of the compression cylinder, piston and piston drive means, air blowing means and air heating means.

FIG. 3 is a perspective view of the compression cylinder, piston and piston drive means, air blowing means and air heating means.

FIG. 4 is a perspective top view of the apparatus with top panel of the housing wall removed to reveal the internal structure.

FIG. 5 is a perspective view of the apparatus housing frame, circuit and circuit board.

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various FIGURES are designated by the same reference numerals.

### First Preferred Embodiment

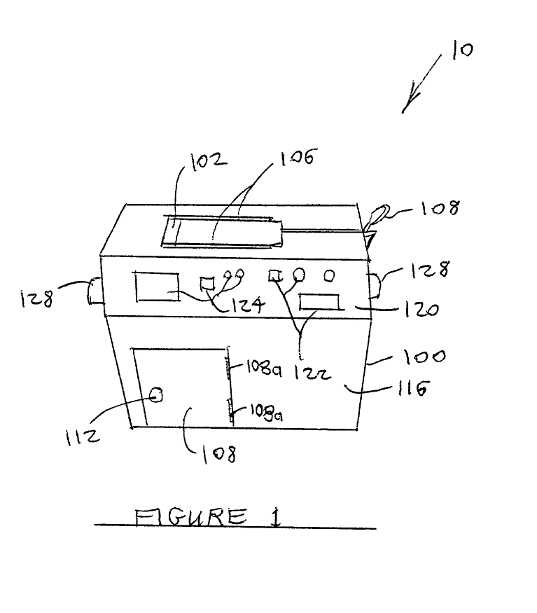

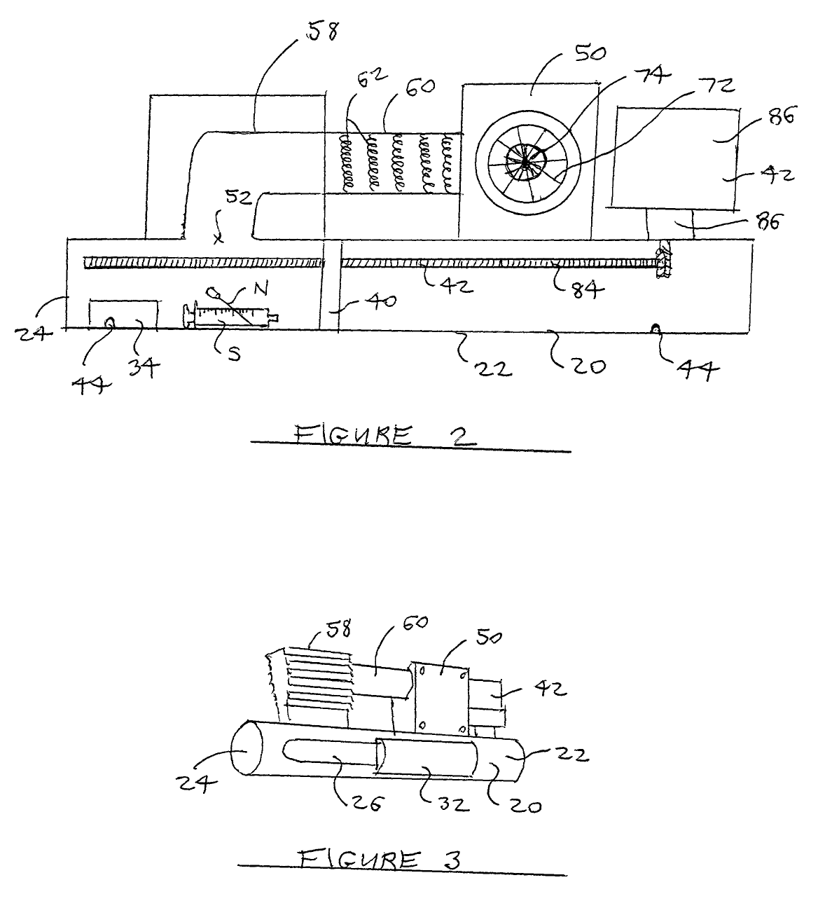

Referring to FIGS. 1-5, an apparatus 10 is disclosed which disposes of infectious and sharps waste by sterilizing, melting and compressing plastic hypodermic syringes S and sterilizing, crushing and encasing needles N in melted syringe material. Apparatus 10 includes a waste compression cylinder 20 having a cylinder side wall 22 and a closed cylinder abutment end wall 24 and containing a waste compression piston 40 drivably connected to piston drive means 42, a cylinder waste receiving port 26 in cylinder side wall 22 and a corresponding cylinder waste receiving door 32, a waste releasing port 34 in cylinder side wall 22, and waste receiving door displacement means 28 which automatically opens and closes the waste receiving door 32 to pass waste W into the cylinder 20. See FIGS. 2 and 3. Piston drive means 42 slides the piston 40 away from cylinder abutment end wall 24 to open space for receiving waste W and slides the piston 40 toward and into close proximity with the cylinder abutment end wall 24 to crush needles N and compress melted syringe material around needles N. Two piston stop switches 44 are provided in cylinder 20 which are electrically connected to piston drive means 42 to stop piston drive means 42 when the piston abuts and depresses either switch 44, thereby limiting the range of movement of the piston 40. See FIG. 2. A sterilizing air blowing means 50 is provided and oriented to blow sterilizing air into the cylinder 20 through an entry air port 52 and air heating means 60 containing heating elements 62 for heating the sterilizing air to a sterilizing temperature.

The air blowing means 60 contains circuitry permitting setting of a pre-set air blowing duration which is selected to be sufficient to cause sterilization of needles N and syringes S contained within the cylinder 20. The sterilizing air temperature is preferably elevated by the air heating means 60 to a sufficient level that it partially melts the syringe S material during the pre-set duration. The air blowing means 50 preferably includes a squirrel cage blower 72 drivably connected to a blower motor 74 and delivering air into the air heating means 60 which is a tubular heating element preferably in the form of a cylinder, and from the heating element 60 into an elbow pipe 58 which is sealingly connected to the air entry port 52. The air passes through the cylinder 20 and out through the waste releasing port 34.

Immediately subsequent to the timed delivery of sterilized air into compression cylinder 20, the piston drive means 42 is activated and causes the piston 40 to advance toward and into close proximity with the cylinder abutment end wall 24, causing the needles N to bend and double over and causing the partially melted syringes S to become compressed and to flow around the bent, sterilized needles N, thereby encasing the needles N in the syringe S material. Then the piston 40 is withdrawn by the piston drive means 42 to its initial position spaced apart from the abutment end wall 24 and the compressed and sterilized waste W drops from the cylinder 20, preferably into a waste collection vessel 80 positioned below the cylinder waste releasing port 34.

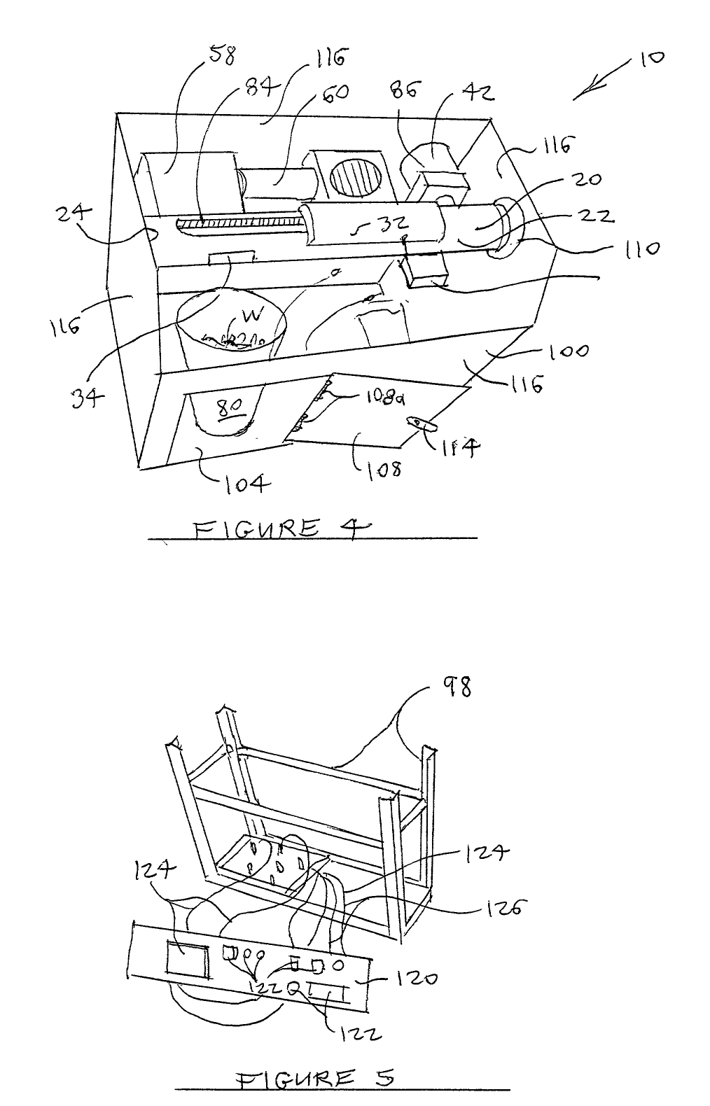

All of these elements preferably are contained within an apparatus housing 100 assembled around an apparatus housing frame 98 containing opposing cylinder mounting structures 110 which hold the cylinder 20 in a substantially horizontal position. See FIGS. 4 and 5. Housing 100 preferably includes a housing wall 116 a housing waste receiving opening 102 above covered by a housing waste receiving door 104 and registering with the cylinder waste receiving port 26. The housing waste receiving port is preferably closed by a housing waste receiving door which is preferably slidably mounted in opposing channel guides 106 and is manually slid by operating a lever mechanism 108 of conventional design. See FIG. 1. The waste collection vessel 80 is preferably removably fitted within the housing 100 below the cylinder waste releasing port 34, and a vessel removal port 104 is provided in the housing 100 for periodic removal and emptying of the collection vessel 80 when the collection vessel 80 becomes full. A vessel removal door 108 pivotally mounted on hinges 108a preferably covers the vessel removal port 104 and is provided with a door opening knob 112 rotatably connected to a turn release door opening mechanism 114.

The piston 40 is preferably a plunger disk having a threaded bore and the piston drive means 42 is preferably a drive screw 84 engagingly passing through the threaded bore and drivably connected to a piston drive motor 86.

Apparatus 10 preferably includes an apparatus circuit board 120 mounted within the apparatus housing 100, the circuit board 120 being connected to external apparatus controls 122 by circuit wires 124. The preferred receiving door displacement means 28 is a solenoid 92 drivably connected to receiving door 32 by linkages which are operated by solenoid switches 94 and controllingly connected to circuit timers and operational sequencing elements of conventional design contained within the apparatus circuit 126 which control the operation of the receiving door displacement means 28 and the piston drive means 42. The apparatus 10 controls include disposal a starting switch which, for safety reasons, preferably includes two spaced apart disposal starting switches 128 which are interconnected such that they must be depressed simultaneously to start the above-described sequence of operating events and functions. These two disposal starting switches 128 are preferably located on opposite ends of the apparatus housing 100, so that both hands of the operator are safely occupied as the apparatus 10 begins operation and thus cannot be injured by apparatus 10. Housing 100 is preferably shaped as an elongate box, and is preferably formed of aluminum or stainless steel.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

I claim as my invention:

1. An apparatus for sterilizing and destroying hypodermic syringes and needles, comprising
a waste compression cylinder having a cylinder side wall and a closed cylinder abutment end wall, and having a cylinder waste receiving port in said cylinder side wall and a waste releasing port in said cylinder side wall;
a waste compression piston slidably retained within said waste compression cylinder;
piston drive means drivably connected to said waste compression piston for driving said piston away from said abutment end wall to open space for receiving waste within said compression cylinder and for driving said piston toward and into close proximity with said cylinder abutment end wall to crush needles;
sterilizing air blowing means oriented to blow sterilizing air into said compression cylinder;
and air heating means for heating the sterilizing air to a sterilizing temperature.

2. The apparatus of claim 1, additionally comprising a waste receiving door movably covering said waste receiving port.

3. The apparatus of claim 3, additionally comprising a waste receiving door displacement means for automatically opening and closing said waste receiving door to pass waste into said cylinder.

4. The apparatus of claim 1, additionally comprising timer means for setting a duration for operation of said air blowing means sufficient to cause sterilization of needles and syringes contained within said compression cylinder.

5. The apparatus of claim 1, additionally comprising a waste collection vessel positioned below said cylinder waste releasing port.

6. The apparatus of claim 5, additionally comprising an apparatus housing having a housing wall and containing said compression cylinder and comprising compression cylinder mounting means holding said compression cylinder in a substantially horizontal position.

7. The apparatus of claim 6, additionally comprising a housing waste receiving opening in said housing wall located above and registering with said cylinder waste receiving port.

8. The apparatus of claim 7, additionally comprising a housing waste receiving door and housing waste receiving door displacement means.

9. The apparatus of claim 8, additionally comprising a waste collection vessel removably retained within said housing below said cylinder waste releasing port.

10. The apparatus of claim 9, additionally comprising a vessel removal port and vessel removal door removably covering said vessel removal port for providing access to said collection vessel for periodic removal and emptying of said collection vessel.

11. The apparatus of claim 1, additionally comprising an apparatus circuit comprising operation duration and sequencing means controlling operation of said cylinder waste receiving door and said piston drive means.

12. The apparatus of claim 11, additionally comprising an apparatus circuit board electrically connected to said apparatus circuit and having apparatus controls.
